(19) United States
(12) Patent Application Publication
(10) Pub. No.: US 2024/0410977 A1
(43) Pub. Date: Dec. 12, 2024

(54) SENSOR CONTROL SYSTEM, METHOD, AND PROGRAM

(71) Applicant: NEC Corporation, Minato-ku, Tokyo (JP)

(72) Inventors: Akihiro YATABE, Tokyo (JP); Hiroshi Chishima, Tokyo (JP); Masanori Kato, Tokyo (JP)

(73) Assignee: NEC Corporation, Minato-ku, Tokyo (JP)

(21) Appl. No.: 18/726,152

(22) PCT Filed: Jan. 21, 2022
(86) PCT No.: PCT/JP2022/002170

§ 371 Date: Jul. 2, 2024

(51) Int. Cl. G01S 7/40; G01S 13/08; G06N 7/01; H04L 67/125

(52) U.S. Cl. CPC G01S 7/4008; G01S 13/08; G06N 7/01; H04L 67/125

(57) ABSTRACT

The input means 81 accepts input of position of a sensor that acquires a moving object and direction of the sensor, as well as position of the moving object. The model construction means 82 constructs Ising model data that models an optimization problem to optimally assign a moving object to be acquired by the sensor from a relationship between a position of the moving object and an area that can be acquired based on a position of the sensor and a direction of the sensor. The optimization processing means 83 maps the Ising model data to an annealing machine to obtain an execution result indicating a moving object to be assigned to the sensor. The control means 84 controls the sensor to acquire an assigned moving object based on the execution result.

### TECHNICAL FIELD

This invention relates to a sensor control system, a sensor control method, and a sensor control program for controlling a sensor that acquires a moving object.

### BACKGROUND ART

Technology has been developed to acquire a moving object using a sensor. For example, Patent Literature 1 describes a system that uses multiple sensors to acquire a moving object. The system described in Patent Literature 1 defines a cost based on the probability of a moving object being in the sensing range of a sensor and the capacity of the sensor, and determines which sensor to assign to each moving object so as to minimize the cost.

### CITATION LIST

### Patent Literature

Patent Literature 1: U.S. Application Publication No. 2005/0004759.

### SUMMARY OF INVENTION

### Technical Problem

The problem of assigning multiple moving objects to multiple sensors to be controlled is so-called combinatorial optimization problem. Therefore, as the number of sensors, moving objects, and the driving range of sensors (e.g., the number of angular patterns to be driven) increases, it is difficult to calculate all combination patterns. For example, a general method using algorithm such as greedy algorithm is difficult to use in realistic time (e.g., real time) because of the accuracy and speed challenges of the results.

In the system described in the Patent Literature 1, optimization is performed by genetic algorithms, a branch-and-bound method, and an annealing method as well as auction algorithms to assign a moving object to various tracking system resource. However, there are no examples of applying an annealing method for more detailed sensor resource assignment and optimal control.

Therefore, the purpose of this invention is to provide a sensor control system, a sensor control method, and a sensor control program that can control multiple sensors acquiring multiple moving objects in a realistic time.

### Solution to Problem

A sensor control system according to the present invention includes an input means which accepts input of position of a sensor that acquires a moving object and direction of the sensor, as well as position of the moving object, a model construction means which constructs Ising model data that models an optimization problem to optimally assign a moving object to be acquired by the sensor from a relationship between a position of the moving object and an area that can be acquired based on a position of the sensor and a direction of the sensor, an optimization processing means which maps the Ising model data to an annealing machine to obtain an execution result indicating a moving object to be assigned to the sensor, and a control means which controls the sensor to acquire an assigned moving object based on the execution result.

A sensor control method according to the present invention includes: accepting input of position of a sensor that acquires a moving object and direction of the sensor, as well as position of the moving object: constructing Ising model data that models an optimization problem to optimally assign a moving object to be acquired by the sensor from a relationship between a position of the moving object and an area that can be acquired based on a position of the sensor and a direction of the sensor: mapping the Ising model data to an annealing machine to obtain an execution result indicating a moving object to be assigned to the sensor; and controlling the sensor to acquire an assigned moving object based on the execution result.

A sensor control program according to the present invention causes a computer to execute: an input process of accepting input of position of a sensor that acquires a moving object and direction of the sensor, as well as position of the moving object: a model construction process of constructing Ising model data that models an optimization problem to optimally assign a moving object to be acquired by the sensor from a relationship between a position of the moving object and an area that can be acquired based on a position of the sensor and a direction of the sensor: an optimization processing process of mapping the Ising model data to an annealing machine to obtain an execution result indicating a moving object to be assigned to the sensor, and a control process of controlling the sensor to acquire an assigned moving object based on the execution result.

### Advantageous Effects of Invention

According to the present invention, it is possible to control multiple sensors acquiring multiple moving objects in a realistic time.

### BRIEF DESCRIPTION OF DRAWINGS

FIG. 1 It depicts a block diagram showing a configuration example of one example embodiment of a sensor control system.

FIG. 2 It depicts an explanatory diagram showing an example of an operation in which a sensor acquires a moving object.

FIG. 3 It depicts an explanatory diagram showing a method for deriving a set of moving objects that cannot be acquired.

FIG. 4 It depicts an explanatory diagram showing an example of variables used in a QUBO-style formula.

FIG. 5 It depicts an explanatory diagram showing an example of variables used in a QUBO-style formula.

FIG. 6 It depicts an explanatory diagram showing an example of the amount of difference in sensor direction.

FIG. 7 It depicts an explanatory diagram showing the situation where the sensor assigned to a moving object changes.

FIG. 8 It depicts an explanatory diagram showing an example of the process of limiting the upper limit of resources by setting a dummy sensor.

FIG. 9 It depicts an explanatory diagram showing an example of an accuracy point.

FIG. 10 It depicts an explanatory diagram showing an example of the process of preferentially acquiring an important target.

FIG. 11 It depicts an explanatory diagram showing an example of the process of using an important sensor.

FIG. 12 It depicts a flowchart showing an example of the operation of the sensor control system.

FIG. 13 It depicts an explanatory diagram showing an example of applying a sensor control system to acquire the current position of a marathon runner.

FIG. 14 It depicts a block diagram showing the outline of the sensor control system according to the present invention.

### DESCRIPTION OF EMBODIMENTS

The purpose of this invention is to control multiple sensors acquiring multiple moving objects in a realistic time. Realistic time here means a time to the extent that it is possible to control multiple sensors acquiring each moving object in real time. The following is a description of the example embodiment of the invention with reference to the drawings.

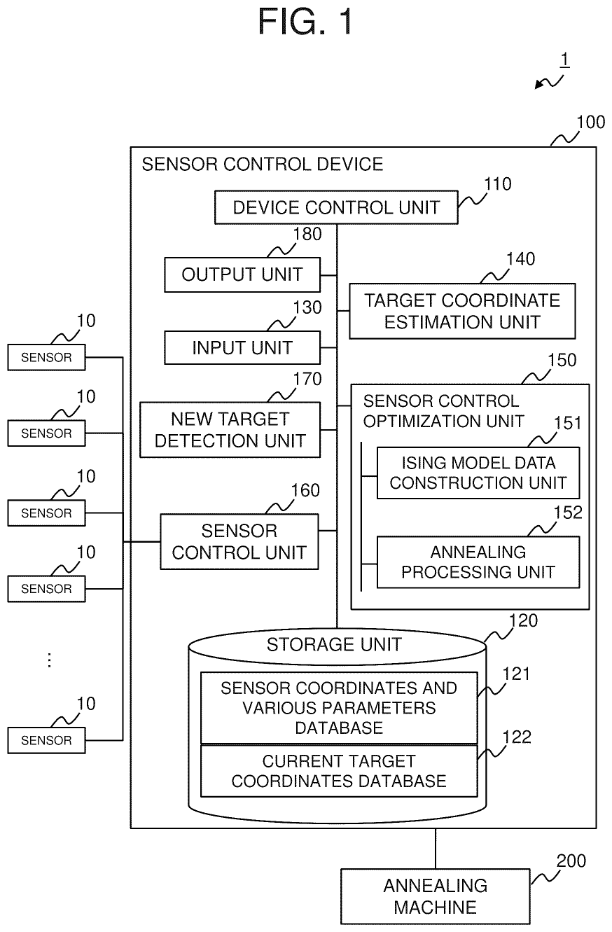

FIG. 1 is a block diagram showing a configuration example of one example embodiment of a sensor control system. A sensor control system 1 in this example embodiment includes multiple sensors 10, a sensor control device 100, and an annealing machine 200.

The annealing machine 200 is a dedicated device for obtaining a ground state of the Hamiltonian of the Ising model (Ising model data) and executes annealing based on the Ising model generated by the sensor control device 100. The Ising model is a simplified model that calculates the spin direction of atoms constituting a crystal, and is one of the formulations of the combinatorial optimization problem.

More specifically: an annealing machine is a device that probabilistically finds the value of a binary variable that minimizes or maximizes the objective function (i.e., Hamiltonian) of an Ising model with a binary variable as an argument. The binary variable may be realized in a classical or quantum bit.

The aspect of the annealing machine 200 in this example embodiment is arbitrary. The annealing machine 200 may be composed of any hardware that probabilistically finds the value of a binary variable that minimizes or maximizes an objective function with a binary variable as an argument. The annealing machine 200 may be, for example, a non-von Neumann architecture in which the objective function is implemented by hardware in the form of an Ising model. The annealing machine 200 may be a quantum annealing machine or a general annealing machine.

Here, the QUBO (Quadratic Unconstrained Binary Optimization) model, which can be transformed one-to-one with the Ising model, is one formulation of the combinatorial optimization problem. Therefore. QUBO-modeled combinatorial optimization problem can be solved by an annealing machine. Therefore, the following description describes the case where the Ising model to be optimized by the annealing machine 200 is represented in QUBO form.

The sensor 10 is a sensor for acquiring a moving object with multiple resources in the sensor control system 1 of this example embodiment. There are multiple sensors 10 in this example embodiment, and they are connected to the sensor control device 100 in a communication-enabled manner (e.g., wireless communication, etc.).

The sensor 10 of this example embodiment is assumed to be a directional sensor and acquires the assigned moving object based on the control by the sensor control device 100. The sensor 10 of this example embodiment is assumed to be able to change the direction in which it acquires by rotating around a specific axis. Furthermore, it is assumed that the resource available to the sensor 10 in this example embodiment for acquiring moving objects (the maximum number of moving objects that can be acquired) is fixed.

The position of the sensor 10 may or may not be fixed. For example, the sensor 10 may be mounted on a vehicle, drone, or other device, and the position of the sensor 10 may change as the moving object to be acquired moves.

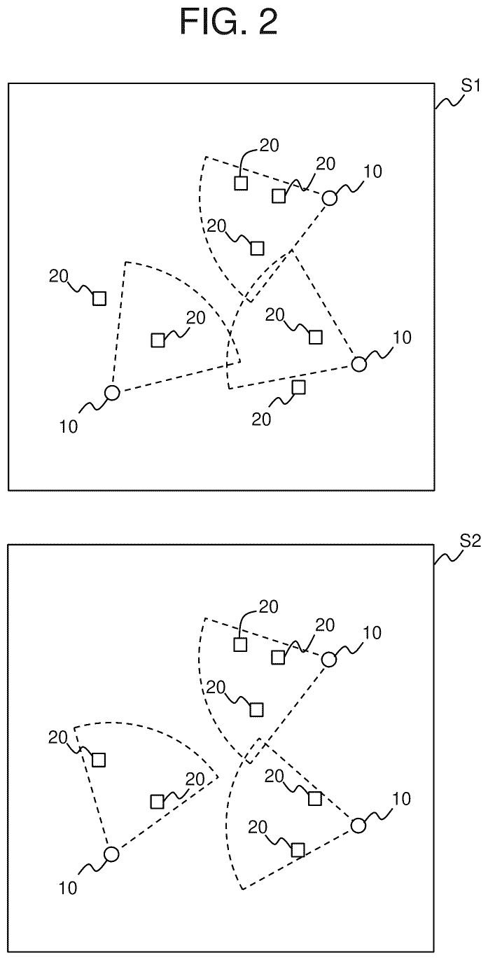

FIG. 2 is an explanatory diagram showing an example of an operation in which a sensor acquires a moving object. The example shown in FIG. 2 shows the operation of using multiple sensors 10 to acquire multiple moving objects 20. The range shown by the dashed line in the example in FIG. 2 is the range in which the sensor 10 can acquire the moving objects 20.

The example shown in FIG. 2 shows that in state S1, three sensors 10 acquire five moving objects 20. The sensor control system 1 in this example embodiment controls the sensors to minimize the number of moving objects 20 that cannot be acquired (i.e., minimize the number of missed acquisitions of moving objects 20). Then, by appropriately determining and controlling each sensor to be assigned to acquire a moving object, as shown in state S2, three sensors 10 can acquire more moving objects (seven moving objects 20). The example shown in FIG. 2 indicates that many moving objects can be acquired by changing the angle of the sensors 10.

In the following description, the case in which the moving object is a flying object (e.g., missile, drone, etc.) is illustrated. In this case, the aspect of sensor 10 is, for example, a radar. The moving object is not limited to a flying object, but may be, for example, a person or a mobile terminal. If the moving object is a person, the aspect of the sensor 10 used is, for example, a camera. When the moving object is a mobile terminal, the antenna of a base station may be used as the aspect of the sensor 10.

The sensor control device 100 includes a device control unit 110, a storage unit 120, an input unit 130, a target coordinate estimation unit 140, a sensor control optimization unit 150, a sensor control unit 160, a new target detection unit 170, and an output unit 180.

The device control unit 110 controls various functions of the sensor control device 100.

The storage unit 120 stores various information used by the sensor control device 100 for processing. The storage unit 120 in this example embodiment also stores a sensor coordinates and various parameters database 121 and a current target coordinates database 122.

The sensor coordinates and various parameters database 121 is a database that stores various specification information, such as the position of the sensor 10 and parameter settings. For example, when the position of the sensor 10 changes, the sensor coordinates and various parameters database 121 may be sequentially updated with the position of the sensor 10 after the change. The position of the sensor 10 after the change may be obtained, for example, from the GPS (Global Positioning System) or directly from a device or the like equipped with the sensor 10.

Further, when the direction of the sensor 10 (hereinafter simply referred to as the direction of the sensor 10) is changed by control, the sensor coordinates and various parameters database 121 may sequentially update the direction of the sensor 10 after the change. The direction of the sensor 10 after the change may be obtained from the sensor control unit 160 or the sensor control optimization unit 150 described below; or directly from each sensor 10.

The current target coordinates database 122 stores information indicating position at the current time t of the moving object that the sensor 10 is trying to acquire (hereinafter sometimes referred to as the current target coordinates). Since the moving object is, as the name implies, an object that moves, it is difficult to ascertain its present time position strictly speaking. Therefore, the current target coordinates database 122 may store as current target coordinates information indicating the position of the moving object at the most recent time t-1 when it was acquired, or information indicating the position of the moving object at the current time t as estimated by the target coordinate estimation unit 140 described below:

The input unit 130 accepts input of various types of information used to control the sensor 10. For example, when the position of the sensor 10 changes, the input unit 130 may accept input of the position of the sensor 10 after the change from the sensor 10 or a device equipped with the sensor 10. The input unit 130 may also accept input of information indicating the current status of the sensor 10, such as the current direction, directly from the sensor 10 or from information stored in the storage unit 120. The input unit 130 may be included in the sensor control optimization unit 150 described below:

The target coordinate estimation unit 140 estimates the position of the moving object at the current time t (i.e., the current target coordinates). The method by which the target coordinate estimation unit 140 estimates the current target coordinates is arbitrary. For example, the target coordinate estimation unit 140 may identify the speed of the moving object based on multiple observations of each moving object, and estimate the current target coordinates of the moving object based on the identified speed and the observed position of the moving object.

For example, it is assumed that the position of the moving object at time tₐ is Pₐ and the velocity is Vₐ. In this case, the target coordinate estimation unit 140 may estimate the position P_{b} of the moving object at time t_{b} as P_{b}=P_{b}+Vₐ*(t_{b}−tₐ). Furthermore, the target coordinate estimation unit 140 may identify the acceleration of the moving object based on multiple observations for each moving object, and may also take into account the identified acceleration to estimate the position of the moving object.

The sensor control optimization unit 150 performs the process of determining the sensor to be assigned to acquire the moving object. Therefore, the device that implements the sensor control optimization unit 150 can be referred to as an assignment decision device. In other words, the sensor control optimization unit 150 may be realized as a single device. The sensor control optimization unit 150 includes an Ising model data construction unit 151 and an annealing processing unit 152.

The Ising model data construction unit 151 obtains information indicating the state of the sensor 10 and the position of the moving object. Specifically, the Ising model data construction unit 151 accepts input of information indicating the position and direction of the sensor 10 at the time of acquisition t, and information indicating the position of the moving object. The information indicating the position of the moving object at the time of acquisition t is, for example, the current target coordinates.

The Ising model data construction unit 151 may obtain information indicating the position and direction of the sensor 10 and the position of the moving object from the sensor coordinates and various parameters database 121 and the current target coordinates database 122 stored in the storage unit 120. The Ising model data construction unit 151 may also obtain the current target coordinates from the target coordinate estimation unit 140, or may directly obtain information indicating the position and direction of the sensor 10 from the sensor 10.

Next, the Ising model data construction unit 151 constructs Ising model data (hereinafter, it may be simply referred to as a model.) that models an optimization problem to optimally assign the moving object to be acquired by the sensor 10 from the relationship between an area that can be acquired based on the position of the sensor 10 and direction of the sensor 10, and the position of the moving object.

First, the Ising model data construction unit 151 derives the set of moving objects that cannot be acquired from the relationship between the position and direction of the sensors 10 and the position of the moving objects. Hereafter, each sensor 10 is denoted by n, the direction of sensor 10 is denoted by d, and the moving object is denoted by α. The set of moving objects that cannot be acquired is denoted by T⁻_{n,d}(T⁻ indicates a superscript bar).

In this example embodiment, it is assumed that for each sensor 10, the acquirable range is predefined based on the position and direction of the sensor itself. The acquirable range is defined with respect to distance and direction. For example, the acquirable range is defined as the range where the distance from the sensor is more than β₁ [m] and less than β₂ [m], the range between −γ₁ [degree] and γ₂ [degree] (γ₁, γ₂, >0)), with the front direction of the sensor 10 as the reference direction ( ) degree, and so on.

In this case, the Ising model data construction unit 151 identifies the acquirable range of sensor 10 for each posture that sensor 10 can take based on the information indicating the acquirable range and the position of sensor 10. Then, the Ising model data construction unit 151 identifies moving objects that are not included in the specified acquirable range among the moving objects to be acquired, and derives a set of moving objects that cannot be acquired.

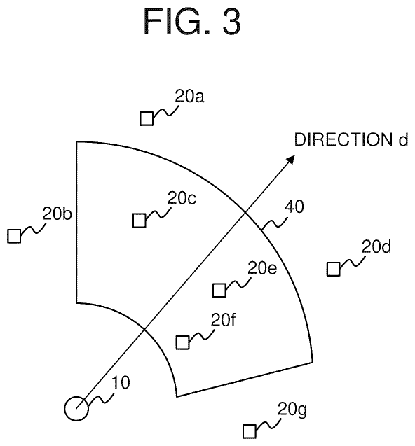

FIG. 3 is an explanatory diagram showing a method for deriving a set of moving objects that cannot be acquired. In the example shown in FIG. 3, it is assumed that the moving objects to be acquired exist from moving objects 20a to 20g, and that an area 40 is the range where the objects can be acquired with respect to the direction d of the sensor 10. In this case, the Ising model data construction unit 151 identifies the moving objects 20a, 20b, 20d, and 20g that do not exist within the area 40 as moving objects that cannot be acquired, and derives these sets as the set of moving objects that cannot be acquired.

Next, the Ising model data construction unit 151 constructs Ising model data that models the optimization problem to optimally assign moving objects to be acquired by each sensor. In this example embodiment, an optimization problem modeled in QUBO-style that can be converted to Ising model data is exemplified.

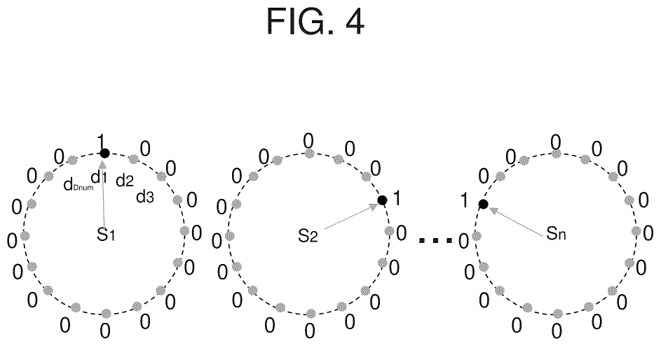

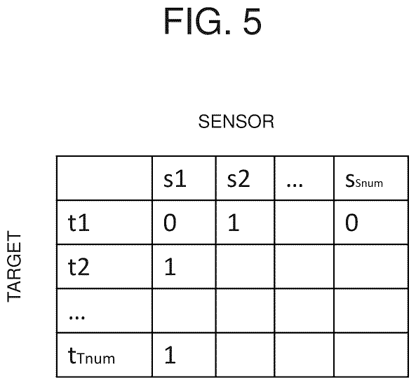

FIG. 4 and FIG. 5 are explanatory diagrams showing an example of variables used in a QUBO-style formula. As shown in FIG. 4, the variable indicating that the nth sensor is facing or not facing direction d (i.e., the variable representing the direction of the sensor) is denoted as s_{n,d} ∈{0, 1}. When the value of s_{n,d} is 1, it indicates that the nth sensor is facing the direction d, and when the value of s_{n,d} is 0, it indicates that the nth sensor is not facing the direction d.

As shown in FIG. 5, the variable indicating that the nth sensor acquires or does not acquire the moving object α is denoted as x_{n,α}={0, 1}. When the value of x_{n,α} is 1, it indicates that the nth sensor acquires the moving object α, and when the value of x_{n,α} is 0, it indicates that the nth sensor does not acquire the moving object α.

In this example embodiment, the Ising model data construction unit 151 constructs a model (mathematical formula) representing, in QUBO-style, an objective function that minimizes the number of moving objects not assigned to each sensor (i.e., minimizes the number of missed acquisitions of moving objects assigned to each sensor), with a constraint that at least the number of moving objects to be acquired by each sensor does not exceed a defined upper limit. The upper limit mentioned above is, for example, the resource available to the sensors 10 for acquiring moving objects (i.e., the maximum number of moving objects that can be acquired). The objective function that minimizes the number of missed acquires is expressed in Equation 1 below:

$$\begin{matrix}[ Math . 1 ] & \\ minimize {\sum }_{α = 1}^{Tnum} {( 1 + {\sum }_{n = 1}^{Snum - 1} {z}_{n , α} - {\sum }_{n = 1}^{Snum} {x}_{n , α} )}^{2} & ( Equation 1 )\end{matrix}$$

In Equation 1, Tₙᵤₘ is the number of moving objects and Sₙᵤₘ is the number of sensors. In addition, Z_{n,α} is an auxiliary variable for representing any number from 0 to the number of sensors. This causes the value in parentheses in Equation 1 to be 0 when the number of sensors to acquire for a moving object is 1 to Sₙᵤₘ, and 1 when the number is 0.

Since it is considered inefficient to acquire a single moving object with a large number of sensors, the number of sensors acquiring a single moving object may be limited to one or two. In this case, the objective function to minimize the number of missed acquisitions can be expressed by Equation 2 shown below, which also has the advantage of eliminating the need to use the auxiliary variable z.

$$\begin{matrix}[ Math . 2 ] & \\ minimize {\sum }_{α = 1}^{Tnum} [ {( 1.5 - {\sum }_{n = 1}^{Snum} {x}_{n , α} )}^{2} - 0.25 ] & ( Equation 2 )\end{matrix}$$

In this example embodiment, since it is assumed that each sensor 10 points in only one direction, a constraint function representing that each sensor 10 points in only one direction is expressed by Equation 3 below. In Equation 3, C₁ represents a constant and Dum represents the number of directions that the sensors can point. This corresponds to each sensor facing one direction in FIG. 4.

$$\begin{matrix}[ Math . 3 ] & \\ {C}_{1} {\sum }_{n = 1}^{Snum} {( 1 - {\sum }_{d = 1}^{Dnum} {s}_{n , d} )}^{2} & ( Equation 3 )\end{matrix}$$

And since the assignment of moving objects that cannot be acquired to a sensor should be suppressed, the constraint function that represents the suppression of assigning moving objects that cannot be acquired to a sensor is expressed by Equation 4 shown below. Note that C₂ in Equation 4 also represents a constant. T n,d represents the set of moving objects that cannot be acquired by each sensor, as described above. Equation 4 makes it possible to relate the variable s_{n,d}, which represents the posture of the sensor, to the variable x_{n,α}, which indicates whether or not a moving object is assigned to the sensor.

$$\begin{matrix}[ Math . 4 ] & \\ {C}_{2} {\sum }_{n = 1}^{Snum} {\sum }_{d = 1}^{Tnum} {S}_{n , d} {\sum }_{{t}_{α} ∈ {\overline{T}}_{n , d}} {x}_{n , α} & ( Equation 4 )\end{matrix}$$

Furthermore, the constraint function, which represents that the number of moving objects to be acquired by each sensor should not exceed a defined upper limit, is expressed by Equation shown below. C₃ in Equation 5 represents a constant and capa represents the upper limit. In addition, y_{n,m} is an auxiliary variable to represent any number between 0 and the upper limit. This corresponds to the fact that the sum of the vertical column directions of the table in FIG. 5 is suppressed within the upper limit.

$$\begin{matrix}[ Math . 5 ] & \\ {C}_{3} {\sum }_{n = 1}^{Snum} {[ {\sum }_{m = 1}^{capa} {y}_{n , m} - {\sum }_{α = 1}^{Tnum} {x}_{n , α} ]}^{2} & ( Equation 5 )\end{matrix}$$

At least, the Ising model data construction unit 151 may construct a model obtained by the sum of the objective function shown in Equation 1 or Equation 2 and the constraint function shown in Equation 5. This makes it possible to construct an objective function that minimizes the number of moving objects not assigned to each sensor, with the constraint that the number of moving objects to be acquired by each sensor does not exceed a defined upper limit.

Furthermore, in addition to the objective function shown above, the Ising model data construction unit 151 may construct a model obtained by adding the constraint functions shown in Equation 3 and Equation 4. This makes it possible to construct an objective function that, in addition to the constraints shown above, constrains each of the sensors 10 to point in only one direction and to suppress the assignment of moving objects to the sensors that cannot be acquired.

Also, in optimization, it may be considered to suppress the degree to which the direction of the sensor changes. This is because, in general, pivoting-type sensors are often unable to sense while changing direction, so less change is more efficient in acquiring moving objects. The constraint function that represents the suppression of the degree to which the sensor's direction changes is expressed by Equation 6 shown below. C₄ in Equation 6 represents a constant and P_{n,d} represents the amount of difference from the previous sensor direction.

$$\begin{matrix}[ Math . 6 ] & \\ H = {C}_{4} {\sum }_{n = 1}^{Snum} {\sum }_{d = 1}^{Dnum} {s}_{n , d} * {P}_{n , d} & ( Equation 6 )\end{matrix}$$

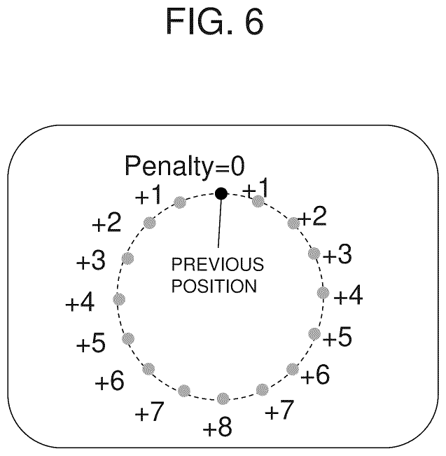

FIG. 6 is an explanatory diagram showing an example of the amount of difference in sensor direction. The example shown in FIG. 6 indicates that the larger the angle from the previous sensor direction, the larger the penalty value.

Also, in optimization, it may be considered to suppress the degree of change in the sensor assigned to the moving object. When a moving object moves out of the area that a sensor can acquire, it is necessary to switch the assignment to another sensor, but this is because sensing is often not possible during this switching (handover), so the fewer the switching, the more efficiently the moving object can be acquired.

The constraint function that represents the suppression of the degree of change in the sensors assigned to the moving object is expressed by Equation 7 shown below. C₅ and C₆ in Equation 7 represent constants, and px_{n,α} is the value of x indicating whether or not a moving object α is assigned to the previous sensor n. DB_{n,α} represents the prediction time that sensor n can continue to acquire the moving object α (hereinafter referred to as time to keep tracking).

$$\begin{matrix}[ Math . 7 ] & \\ H = {C}_{5} {\sum }_{n = 1}^{Snum} {\sum }_{α = 1}^{Tnum} {( {px}_{n , α} - {x}_{n , α} )}^{2} + {C}_{6} {\sum }_{α = 1}^{Tnum} [ - {\sum }_{n = 1}^{Snum} ( {x}_{n , α} * {DB}_{n , α} ) ] & ( Equation 7 )\end{matrix}$$

The time to keep tracking is calculated by estimating the position of the moving object α at each of multiple future time points and determining whether the moving object α at the estimated position can be acquired by sensor n. For example, it is assumed that the control of the posture of the sensor 10 is performed every second. Also, it is assumed that the moving object α at the position estimated for each of t seconds after 1 second is all in a position that can be acquired by sensor n. Further, it is assumed that the moving object α at the position estimated for t+1 seconds later is in a position where it cannot be acquired by the sensor 10. In this case, DB_{n,α}=t.

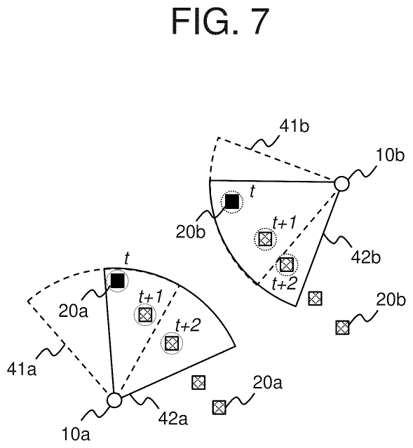

FIG. 7 is an explanatory diagram showing the situation where the sensor assigned to a moving object changes. In the example shown in FIG. 7, it is assumed that a sensor 10a acquires a moving object 20a and a sensor 10b acquires a moving object 20b. Then, it is assumed that the moving object 20a and the moving object 20b are moving toward the lower right direction of the figure, respectively.

In this case, at time t, it is possible to acquire the moving object 20a with the sensor 10a in both the area 41a and the area 42a. Similarly, it is possible to acquire the moving object 20b with the sensor 10b in both the area 41b and the area 42b. However, if acquisition was performed for the area 41a and the area 41b at time t, both the moving object 20a and the moving object 20b will be out of the area where acquisition is possible at time t+2, and it will be necessary to switch sensors or change the direction.

On the other hand, if acquisition was performed for the area 42a and the area 42b at time t, there is no need to switch sensors or change the direction because the moving object 20a and the moving object 20b are still included in the area where they can be acquired at time t+2. Therefore, it is possible to acquire the moving object efficiently.

Furthermore, this example embodiment allows the use of multiple resources of the sensor (specifically; the number of radio wave irradiations by the sensor) to acquire a moving object, thereby improving the accuracy of acquiring the moving object.

In general, the distribution of the target to be acquired can be modeled as a so-called ellipse, which is narrow in the direction the sensor points and wide in the distance direction of the sensor. Therefore, acquiring the moving object with a different sensor has the advantage of reducing the error range because the elliptical distribution overlaps. Furthermore, increasing the number of times the sensor irradiates the radio waves used for acquisition increases the number of sampling times, which also has the advantage of reducing positional errors.

Therefore, in this example embodiment, the combination of sensor resources that can reduce the tracking error of a moving object while minimizing the number of missed acquisitions is also optimized. The premise for such optimization is that each of the sensors 10 can use a predetermined number of resources.

Specifically, the Ising model data construction unit 151 in this example embodiment constructs a model (mathematical equation) representing an objective function in QUBO-style that minimizes the number of missed acquisitions of moving objects assigned to each sensor so that the number of sensors to be acquired and the number of resources used by each sensor for acquiring does not exceed a predetermined upper limit, with a constraint that the number of moving objects to be acquired by each sensor does not exceed a predetermined upper limit. This makes it possible to minimize the number of missed acquisitions and to prevent wasteful use of resources.

For example, it is assumed that the upper limit of the number of sensors to be assigned to one moving object is 3, and the upper limit of the number of resources that each sensor uses for acquisition is 2. In this case, the objective function to minimize the number of missed acquisitions is expressed by Equation 8 shown below. In other words, Equation 1 or Equation 2 shown above can be rewritten as Equation 8 shown below:

$$\begin{matrix}[ Math . 8 ] & \\ minimize {\sum }_{α = 1}^{Tnum} [ {( 3 - {\sum }_{n = 1}^{Snum * 2} {x}_{n , α} - {x}_{dmy 1 , α} - {x}_{dmy 2 , α} )}^{2} ] & ( Equation 8 )\end{matrix}$$

Dmy1 in Equation 8 represents the first dummy sensor, and dmy2 represents the second dummy sensor. That is, x_{dmy1,α} is a variable indicating that the first dummy sensor dmy1 acquires or does not acquire the moving object α, and x_{dmy2,α} is a variable indicating that the second dummy sensor dmy2 acquires or does not acquire the moving object α.

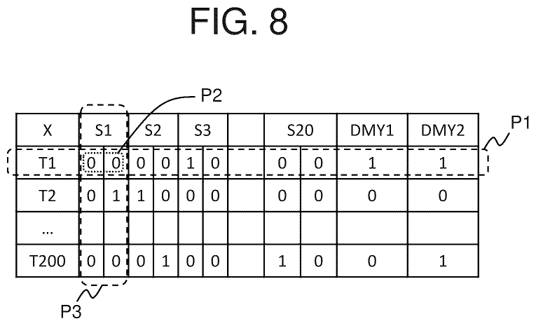

These dummy sensors are non-existent sensors to adjust the upper limit of the number of sensors used for acquisition for a single object so as not to exceed the upper limit. FIG. 8 is an explanatory diagram showing an example of the process of limiting the upper limit of sensor by setting a dummy sensor.

The example shown in FIG. 8 shows the case where each sensor can use a maximum of two resources. The horizontal direction in FIG. 8 indicates the resources of the sensor, and the vertical direction indicates the moving object. The objective function shown in Equation 8 corresponds to an upper limit on the number of resources that each sensor uses to acquire for one moving object, which is the sum of the horizontal direction (e.g., part P1) of the table shown in FIG. 8. Thus, for example, if the upper limit on the number of sensors to be acquired for one moving object is 3 and the upper limit on the number of resources used by each sensor for acquisition is 2, optimizing the objective function means that in the table shown in FIG. 8, the total resources of the sensors (including dummy sensors DMY1 and DMY2) acquiring each moving object (i.e., the sum of each row) is to be optimized to be six.

In this case, the Ising model data construction unit 151 may construct a model that includes constraints on resource usage by one sensor for the same moving object. Specifically, the Ising model data construction unit 151 may construct Ising model data that includes constraints that suppress the use of more resources than a predetermined number. This makes it possible to suppress the use of unnecessary resources. In this case, the resources used by each sensor to acquire one moving object must be smaller than a predetermined number. For example, the constraint function that represents that no one sensor uses more than three resources for the same moving object is represented by Equation 9 shown below.

$$\begin{matrix}[ Math . 9 ] & \\ {\sum }_{n = 1}^{Snum} {\sum }_{α = 1}^{Tnum} {[ 0.5 - ( {x}_{n * 2 , α} + {x}_{n * 2 + 1 , α} ) ]}^{2} - 0.25 & ( Equation 9 )\end{matrix}$$

In the example shown in FIG. 8, Equation 9 indicates, for example, that in part P2, the number of resources that one sensor assigns to one moving object is either 0, 1, or 2. If the upper limit on the number of sensors assigned to one moving object is 3 and the upper limit on the number of resources used by each sensor for acquisition is 2, the constraint function is expressed by the sum of Equation 8 and Equation 9 with the appropriate coefficients.

For the constraint function that expresses that the number of moving objects to be acquired by each sensor should not exceed a defined upper limit, Equation 5 above can be rewritten as Equation 10 shown below.

$$\begin{matrix}[ Math . 10 ] & \\ {C}_{3} {\sum }_{n = 1}^{Snum} {[ {\sum }_{m = 1}^{capa} {y}_{n , m} - {\sum }_{α = 1}^{Tnum} {x}_{n * 2 , α} - {\sum }_{α = 1}^{Tnum} 2 * {x}_{n * 2 + 1 , α} ]}^{2} & ( Equation 10 )\end{matrix}$$

In the example shown in FIG. 8, Equation 10 corresponds to ensuring that the total resources used by one sensor for acquisition does not exceed a defined upper limit, for example, for part P3. Note that the dummy sensor is a sensor for adjusting the number of moving objects to be acquired by each sensor so that it does not exceed a predetermined upper limit, so no upper limit of resources is set.

It is known that tracking accuracy increases as the moving object is closer or acquired by multiple resources, and tracking accuracy improvement due to multiple resources increases as the moving object is farther from the sensor. Furthermore, it is also known that the more orthogonal the angles between radio waves irradiated by direction of the sensor, the higher the tracking accuracy.

Therefore, in this example embodiment, a value indicating the tracking accuracy according to the number of resources of sensors acquiring the moving object, the distance of the moving object, and the direction between the sensors (hereinafter referred to as the accuracy point) may be defined, and this value may be used in the optimization process.

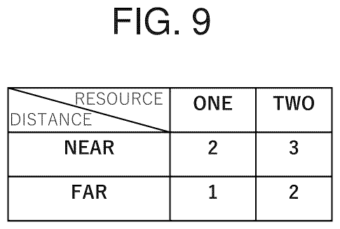

FIG. 9 is an explanatory diagram showing an example of an accuracy point calculated according to the number of sensor resources and the distance of the moving object. The example shown in FIG. 9 is an example of accuracy points where the number of resources consumed by one sensor is 1 or 2 and the distance is also defined in two categories (closer or farther than a given distance). FIG. 9 shows that the tracking accuracy is higher when the moving object is closer and also higher when it is acquired by two resources.

The values of the accuracy points are examples. The number of resources is not limited to two, nor are the distance categories limited to two. The accuracy points may be defined by a function that shows the relationship between the number of resources and the distance, rather than in a tabular form as shown in FIG. 9.

The tracking accuracy according to the direction between sensors is maximally effective when the angles between the radio waves are orthogonal. Therefore, when a moving object is acquired by two sensors s1 and s2, with the accuracy point calculated according to the number of resources of the sensors and the distance of the moving object as the basis point ap, the accuracy point considering the direction between the sensors is calculated, for example, by the formula 11 shown in the example below.

$$Accuracy point = ( {ap}_{s 1} + {ap}_{s 2} ) * ( 1 + sin ( {θ}_{s 1 s 2} ) ) \qquad ( Equation 11 )$$

In Equation 11, apₛ₁ and apₛ₂ indicate the basis points of the sensor s1 and the sensor s2, respectively, and θₛ₁ₛ₂ indicates the angle formed by the radio waves from the sensor s1 and the sensor s2. The accuracy point shown in Equation 11 is maximized when θₛ₁ₛ₂ is a right angle.

When a moving object is acquired by three sensors s1, s2, and s3, the accuracy point considering the direction between the sensors is calculated, for example, by Equation 12, which is shown below:

$$Accuracy point = ( a {p}_{s 1} + a {p}_{s 2} + a {p}_{s 3} ) * ( 1 + 0.5 * ( sin ( {θ}_{s 1 s 2} ) + sin ( {θ}_{s 2 s 3} ) + sin ( {θ}_{s 1 s 3} ) ) ) \qquad ( Equation 12 )$$

In Equation 12, apₛ₁, apₛ₂ and apₛ₃ indicate the basis points of the sensor s1, the sensor s2 and the sensor s3, respectively. In addition, θₛ₁ₛ₂ indicates the angle formed by the radio wave from the sensor s1 and the sensor s2, θₛ₂ₛ₃ indicates the angle formed by the radio wave from the sensor s2 and the sensor s3, and θₛ₁ₛ₃ indicates the angle formed by the radio wave from the sensor s1 and the sensor s3. The accuracy point shown in Equation 12 is maximum when each angle is 120 degrees.

In the above example, the case with two or three sensors is shown, but the same applies to the case with four or more sensors.

Therefore, the Ising model data construction unit 151 may construct a model including a constraint that increases sum of accuracy points calculated as a value indicating tracking accuracy, which becomes higher as the moving object is acquired by multiple resources and becomes higher as the moving object is closer. Furthermore, the Ising model data construction unit 151 may construct a model including a constraint that increases sum of accuracy points indicating tracking accuracy defined so that it becomes higher as the angles between the radio waves irradiated according to the direction of the sensor are perpendicular to each other.

The accuracy point may be defined as a value that takes both of the above tracking accuracy into consideration (i.e., a value indicating tracking accuracy which becomes higher as the moving object is acquired by multiple resources and becomes higher as the moving object is closer to the sensor, and furthermore, defined so that it becomes higher as the angles between the radio waves irradiated according to the direction of the sensor are perpendicular to each other).

For example, if the upper limit on the number of resources used by each sensor to acquire one moving object is 3, the objective function that results in a larger sum of accuracy points is expressed by Equation 13 below: In Equation 13, s2 is other than s1 and includes the first dummy sensor dmy1. Also, s3 is other than s1 and s2 and includes the first dummy sensor dmy1 and the second dummy sensor dmy2.

$$\begin{matrix}[ Math . 11 ] & \\ - {C}_{7} {\sum }_{t} {\sum }_{s 1} {\sum }_{s 2} {\sum }_{s 3} {x}_{s 1 , t} {x}_{s 2 , t} {x}_{s 3 , t} A {P}_{s 1 , s 2 , s 3} & ( Equation 13 )\end{matrix}$$

The method for optimizing for high tracking accuracy using accuracy points has been described above. In addition, in this example embodiment, a method of optimizing assignment by considering moving objects that should be acquired with priority will be explained.

Among multiple moving objects, there may be a moving object that should be acquired by the sensor for as long as possible. Such a moving object is hereinafter referred to as an important target. Furthermore, in comparison with other sensors, a sensor that is predetermined as a sensor that should acquire an important target is referred to as an important sensor. The important sensor is, for example, a sensor that have higher tracking accuracy and performance than other sensors.

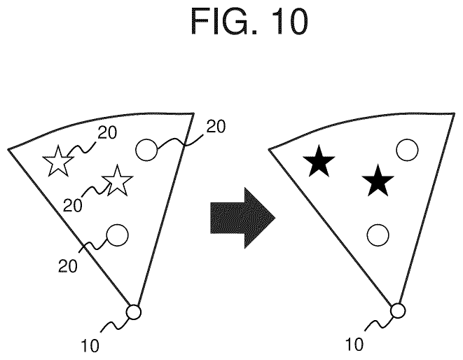

FIG. 10 is an explanatory diagram showing an example of the process of preferentially acquiring an important target. In the example shown in FIG. 10, four moving objects 20 are included in the area that can be acquired by the sensor 10, and the moving object 20 marked with a star is an important target. In this case, two moving objects 20 marked with stars are selected as important targets because the important targets should be acquired first.

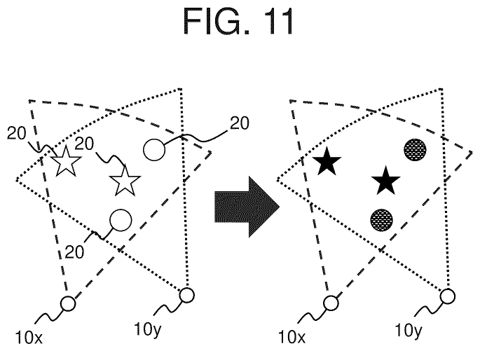

FIG. 11 is an explanatory diagram showing an example of the process of using an important sensor. In the example shown in FIG. 11, a sensor 10x is the important sensor and a sensor 10y is the normal sensor. In the example shown in FIG. 11, four moving objects 20 are included in the area that both the sensor 10x and the sensor 10y can acquire, and the moving object 20 marked with a star is an important target.

In this case, it indicates that the two starred moving objects 20 that are important targets are assigned to the sensor 10x and the remaining two moving objects 20 are assigned to the sensor 10y, because the sensor 10x, the important sensor, should have priority in acquiring important targets.

In order to realize such optimization, the Ising model data construction unit 151 may construct a model whose objective function includes a weighted formula that reduces the value of the objective function as more important targets are assigned to sensors, in order to ensure moving objects that should be assigned preferentially to sensors (that is, important targets) are preferentially assigned to the sensor.

The objective function that includes weighted formulas with the effect that the important target is preferentially assigned to the sensor is, for example, the expression in parentheses in Equation 2 shown above, which is changed to Equation 14 shown below in the case of an important target.

$$\begin{matrix}[ Math . 12 ] & \\ ( 1 + {C}_{target} ) \times [ {( 1.5 - {\sum }_{n = 1}^{S n u m} {x}_{n , α} )}^{2} - 0.25 ] & ( Equation 14 )\end{matrix}$$

C_{target} is a constant predetermined by the administrator or others according to the degree of priority assigned to the important targets. Note that in the case of the important target, the expression in parentheses in Equation 1 shown above may be changed to an expression in which (1+c_{target}) is weighted, similarly to Equation 14.

Furthermore, the Ising model data construction unit 151 may construct a model whose objective function includes a formula that has an effect of reducing a value of the objective function when the important target is assigned to an important sensor, in order to assign moving objects that should be acquired preferentially (i.e., important targets) to important sensors.

The objective function that includes a formula with the effect of preferentially assigning the important target to the important sensor is, for example, the expression in parentheses in Equation 2 shown above, plus Equation 15 shown below in the case of an important target.

$$\begin{matrix}[ Math . 13 ] & \\ - {\sum }_{n ∈ {S}_{important}} {C}_{sensor} {C}_{target} {x}_{n , α} & ( Equation 15 )\end{matrix}$$

Cₛₑₙₛₒᵣ is a constant predetermined by administrator or others according to the degree of incentive given when an important target is assigned to an important sensor. In the case of Equation 1, as in the case of Equation 2, Equation 15 may be added in the case of important targets to the formula in the part of Equation 1 that takes the sum with respect to targets.

In the above explanation, the case in which c_{target} and cₛₑₙₛₒᵣ are constants is shown. However, c_{target} and cₛₑₙₛₒᵣ need not be fixed, but may be values that change fixedly or continuously with respect to a moving object. By continuously changing c_{target} and cₛₑₙₛₒᵣ, the priority can also be continuously changed.

The objective function and constraints used to construct the model have been described above, but the Ising model data construction unit 151 may construct a model by adding any of the above-mentioned Ising models (Hamiltonian) according to constraints, etc., to be defined.

The annealing processing unit 152 maps the modeled optimization problem (i.e., Ising model data) to the annealing machine 200 to obtain the optimal solution. In this way, the annealing processing unit 152 obtains an execution result indicating a moving object to be assigned to the sensor 10. The method of mapping the Ising model to the annealing machine to obtain a solution is widely known, so a detailed description is omitted.

The sensor control unit 160 controls the sensor 10 to acquire the assigned moving object based on the optimization results (execution results) by the sensor control optimization unit 150. Specifically; the sensor control unit 160 changes the direction of the sensor 10 so that it can acquire the moving object assigned to the sensor 10. The control method of the sensor 10 is widely known and is not described in detail here.

The new target detection unit 170 detects new moving objects. For example, if the sensor control system 1 is equipped with a sensor for detecting new moving objects (not shown, hereinafter referred to as a new detection sensor), the new target detection unit 170 may obtain the detection results by the new detection sensor. The new detection sensor may, for example, be installed so that it can exhaustively acquire the space of acquisition for the presence or absence of new moving objects.

Instead of using a new detection sensor, existing sensors 10 may be given the role of detecting new moving objects. Specifically, at least one or more of the multiple sensors 10 may be installed at a location that can acquire the boundary between the space of acquisition and outside the space of acquisition, and the new target detection unit 170 may detect the moving object as a new moving object when a moving object crossing the boundary is detected. Thereafter, the new moving object detected by the new target detection unit 170 is added to the acquire target.

The output unit 180 outputs the execution result by the annealing machine 200. The output unit 180 may, for example, display each sensor and the moving object assigned to each sensor as a target to be acquired, according to their respective positions and directions, in the manner shown in FIG. 3. In other words, the output unit 180 may display the position and direction of each sensor, the area that can be acquired by each sensor according to its state, and the moving object assigned to each sensor as a target to be acquired, correspondingly. Otherwise, the output unit 180 may output, for example, a log indicating the optimization results.

The device control unit 110, the input unit 130, the target coordinate estimation unit 140, the sensor control optimization unit 150 (more specifically; the Ising model data construction unit 151 and the annealing processing unit 152), the sensor control unit 160, the new target detection unit 170, and the output unit 180 are realized by a computer processor (e.g., CPU (Central Processing Unit)) operating according to a program (sensor control program).

For example, a program may be stored in the storage unit 120 of the sensor control device 100, and the processor may read the program and, according to the program, operate as the device control unit 110, the input unit 130, the target coordinate estimation unit 140, the sensor control optimization unit 150 (more specifically, the Ising model data construction unit 151 and the annealing processing unit 152), the sensor control unit 160, the new target detection unit 170, and the output unit 180. The functions of the sensor control device 100 may be provided in a Saas (Software as a Service) format.

The device control unit 110, the input unit 130, the target coordinate estimation unit 140, the sensor control optimization unit 150 (more specifically; the Ising model data construction unit 151 and the annealing processing unit 152), the sensor control unit 160, the new target detection unit 170, and the output unit 180 may each be realized by dedicated hardware. In addition, some or all of the components of each device may be realized by general-purpose or dedicated circuits (circuitry), processors, or a combination of these. They may be configured by a single chip or by multiple chips connected via a bus. Part or all of each component of each device may be realized by a combination of the above-mentioned circuits, etc. and a program.

When some or all of the components of the sensor control device 100 are realized by multiple information processing devices, circuits, etc., the multiple information processing devices, circuits, etc. may be centrally located or distributed. For example, the information processing devices and circuits may be realized as a client-server system, a cloud computing system, or the like, each of which is connected via a communication network.

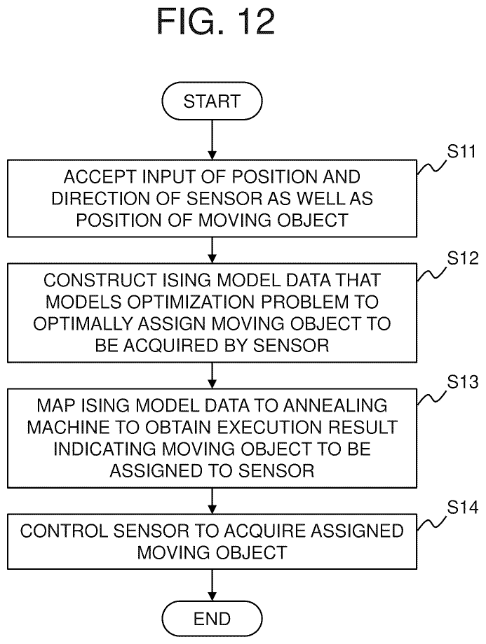

Next, the operation of this example embodiment will be explained. FIG. 12 is a flowchart showing an example of the operation of the sensor control system 1. The input unit 130 accepts inputs of the position and direction of the sensor 10 and the position of the moving object (step S11). The Ising model data construction unit 151 constructs Ising model data that models an optimization problem to optimally assign a moving object to be acquired by the sensor 10 from a relationship of the input information (step S12). The Ising model data construction unit 151 maps the Ising model data to the annealing machine 200 to obtain an execution result indicating the moving object to be assigned to the sensor 10 (step S13). The sensor control unit 160 controls the sensor 10 to acquire the assigned moving object based on the execution result (step S14).

As described above, in this example embodiment, the input unit 130 accepts input of position and direction of the sensor 10 and the position of the moving object, and the Ising model data construction unit 151 constructs Ising model data that models an optimization problem to optimally assign the moving object to be acquired by the sensor 10 from the relationship between the area that can be acquired based on the position and direction of the sensor 10 and the position of the moving object. The Ising model data construction unit 151 maps the Ising model data to the annealing machine 200 to obtain an execution result indicating the moving object to be assigned to the sensor 10, and the sensor control unit 160 controls the sensor 10 to acquire the assigned moving object based on the execution result. Thus, multiple sensors that acquire multiple moving objects can be controlled in a realistic time.

The above example embodiment shows a case in which the sensor control system 1 of this example embodiment is used to acquire flying objects that are moving objects (e.g., missiles, drones, etc.). In other cases, the sensor control system 1 of this example embodiment can be used, for example, to acquire the current position of a marathon runner.

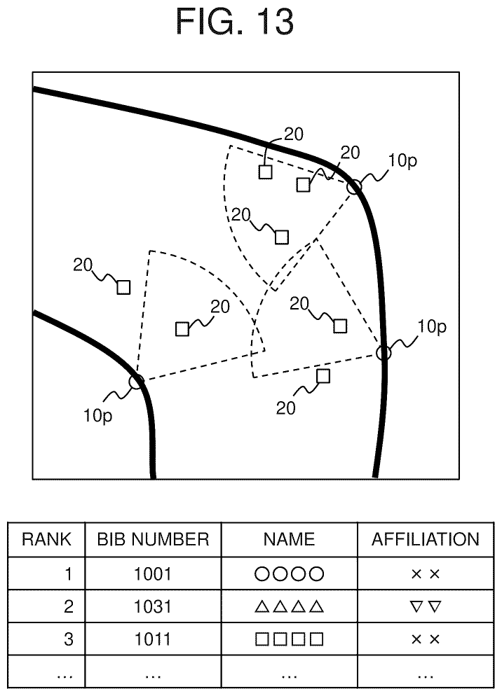

FIG. 13 is an explanatory diagram showing an example of applying a sensor control system in this example embodiment to acquire the current position of a marathon runner. The example shown in FIG. 13 shows a situation in which a camera 10p is installed along the roadside to acquire a runner, which is a moving object 20. The example shown in FIG. 13 also shows the display of the acquired runner's bib number, rank, and name.

Generally marathon times are measured by installing receivers on the course and having runners hold measurement chips (e.g., RS Tag (Runners SporTag)) assigned with the unique identification information of each runner. However, it is time-consuming to register the runner's information on the measurement chip, and it is also complicated to distribute the measurement chip to the runners and have them keep it.

To solve this problem, a method of acquiring runners with multiple cameras by means of face recognition or other methods is considered. However, the number of runners that can be taken with each camera is limited by the processing power of the face recognition process and other factors. In addition, to maintain video quality, it is desirable to minimize the panning motion of the camera taking the picture. Furthermore, to reduce the complexity of the authentication process, it is desirable to be able to reduce the handover (taking over of runners between cameras) process as well.

The sensor control system 1 of this example embodiment can be applied to these issues. Specifically; the Ising model data construction unit 151 can construct a model that minimizes the number of missed acquisitions of runners assigned to each camera, with the constraint that the number of runners assigned to a camera that is a sensor does not exceed a defined limit.

Furthermore, by considering the constraint function shown in Equation 6 above, constraints can be added to control the degree to which the camera direction changes, and by considering the constraint function shown in Equation 7 above, constraints can be added to control the degree to which the camera assigned to the runner changes.

In addition to acquiring the current position of marathon runners, the sensor control system 1 of this example embodiment can also be applied to the service of providing commemorative photos of runners during the competition. Specifically, at marathon events, cameras are installed at each point to take pictures of runners, and a service exists to provide the runners with the pictures taken at a later date.

However, in competitions with a large number of runners, it is generally the case that images are provided with a time lag because it is difficult to perform the process of checking numbers and other information on acquired images in real time. On the other hand, by using this sensor control system 1 of this example embodiment, multiple cameras acquiring multiple runners can be controlled in realistic time, making it possible to provide images identifying individual runners in real time after the competition is over.

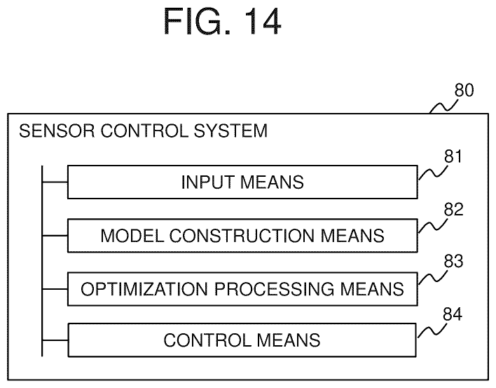

The following is an outline of the invention. FIG. 14 is a block diagram showing the outline of the sensor control system according to the present invention. A sensor control system 80 according to the present invention includes an input means 81 (e.g., the input unit 130) which accepts input of position of a sensor (e.g., the sensor 10) that acquires a moving object (e.g., flying object, person or mobile terminal) and direction of the sensor, as well as position of the moving object, a model construction means 82 (e.g., the Ising model data construction unit 151) which constructs Ising model data that models an optimization problem to optimally assign a moving object to be acquired by the sensor from a relationship between a position of the moving object and an area that can be acquired based on a position of the sensor and a direction of the sensor, an optimization processing means 83 (e.g., the annealing processing unit 152) which maps the Ising model data to an annealing machine to obtain an execution result indicating a moving object to be assigned to the sensor, and a control means 84 (e.g., sensor control unit 160) which controls the sensor to acquire an assigned moving object based on the execution result.

Such a configuration allows control of multiple sensors acquiring multiple moving objects in a realistic time.

The model construction means 82 may construct Ising model data representing an objective function (e.g., Equation 8 and Equation 10 above) that minimizes the number of missed acquisitions of moving objects assigned to each sensor so that the total number of resources used for acquiring one moving object across all sensors does not exceed a predetermined upper limit, with a constraint that the number of moving objects to be acquired by a sensor does not exceed a predetermined upper limit.

The model construction means 82 may construct Ising model data that includes a constraint (e.g., Equation 9 above) that suppress one sensor from using more resources than a predetermined number for the same moving object.

The model construction means 82 may construct Ising model data including a constraint (e.g., Equation 13) that increases sum of accuracy points calculated as a value indicating tracking accuracy, which becomes higher as the moving object is acquired by multiple resources and becomes higher as the moving object is closer to the sensor.

The model construction means 82 may construct Ising model data including a constraint (e.g., Equation 11 and Equation 12) that increases sum of accuracy points indicating tracking accuracy defined so that it becomes higher as the angles between the radio waves irradiated according to the direction of the sensor are perpendicular to each other.

The model construction means 82 may construct Ising model data including, in an objective function (e.g., Equation 14), a weighted formula that reduces a value of the objective function the more an important target, which is a moving object to be acquired preferentially, is assigned to the sensor.

The model construction means 82 may construct Ising model data including, in the objective function (e.g., Equation 15), a formula that has an effect of reducing a value of the objective function when the important target is assigned to an important sensor, which is a sensor predetermined as a sensor that should acquire an important target.

The model construction means 82 may construct model data representing a constraint and an objective function in QUBO-style.

The sensor control system 80 may further include a set derivation means (e.g., the Ising model data construction unit 151) which derives a set of moving objects that cannot be acquired from a relationship between a position of a sensor, a direction of the sensor, and a position of the moving objects. Then, the model construction means 82 may construct a model that includes a constraint that suppresses assignment of moving objects in the set to the sensor.

A part of or all of the above example embodiments may also be described as, but not limited to, the following supplementary notes.

(Supplementary note 1) A sensor control system comprising:
an input means which accepts input of position of a sensor that acquires a moving object and direction of the sensor, as well as position of the moving object:
a model construction means which constructs Ising model data that models an optimization problem to optimally assign a moving object to be acquired by the sensor from a relationship between a position of the moving object and an area that can be acquired based on a position of the sensor and a direction of the sensor:
an optimization processing means which maps the Ising model data to an annealing machine to obtain an execution result indicating a moving object to be assigned to the sensor; and
a control means which controls the sensor to acquire an assigned moving object based on the execution result.

(Supplementary note 2) The sensor control system according to Supplementary note 1, wherein
the model construction means constructs Ising model data representing an objective function that minimizes the number of missed acquisitions of moving objects assigned to each sensor so that the total number of resources used for acquiring one moving object across all sensors does not exceed a predetermined upper limit, with a constraint that the number of moving objects to be acquired by a sensor does not exceed a predetermined upper limit.

(Supplementary note 3) The sensor control system according to Supplementary note 1 or 2, wherein
the model construction means constructs Ising model data that includes a constraint that suppress one sensor from using more resources than a predetermined number for the same moving object.

(Supplementary note 4) The sensor control system according to any one of Supplementary notes 1 to 3, wherein
the model construction means constructs Ising model data including a constraint that increases sum of accuracy points calculated as a value indicating tracking accuracy, which becomes higher as the moving object is acquired by multiple resources and becomes higher as the moving object is closer to the sensor.

(Supplementary note 5) The sensor control system according to Supplementary note 4, wherein
the model construction means constructs Ising model data including a constraint that increases sum of accuracy points indicating tracking accuracy defined so that it becomes higher as the angles between the radio waves irradiated according to the direction of the sensor are perpendicular to each other.

(Supplementary note 6) The sensor control system according to any one of Supplementary notes 1 to 5, wherein
the model construction means constructs Ising model data including, in an objective function, a weighted formula that reduces a value of the objective function the more an important target, which is a moving object to be acquired preferentially, is assigned to the sensor.

(Supplementary note 7) The sensor control system according to Supplementary note 6, wherein
the model construction means constructs Ising model data including, in the objective function, a formula that has an effect of reducing a value of the objective function when the important target is assigned to an important sensor, which is a sensor predetermined as a sensor that should acquire an important target.

(Supplementary note 8) The sensor control system according to any one of Supplementary notes 1 to 7, wherein
the model construction means constructs model data representing a constraint and an objective function in QUBO-style.

(Supplementary note 9) The sensor control system according to any one of Supplementary notes 1 to 8, further comprising:
a set derivation means which derives a set of moving objects that cannot be acquired from a relationship between a position of a sensor, a direction of the sensor, and a position of the moving objects, wherein
the model construction means constructs a model that includes a constraint that suppresses assignment of moving objects in the set to the sensor.

(Supplementary note 10) The sensor control system according to any one of Supplementary notes 1 to 9, comprising:
an output means which displays an area that each sensor can acquire according to a position and direction of each sensor, and a sensor status, in association with the moving object assigned to each sensor as a target to be acquired.

(Supplementary note 11) An assignment decision device comprising:
an input means which accepts input of position of a sensor that acquires a moving object and direction of the sensor, as well as position of the moving object:
a model construction means which constructs Ising model data that models an optimization problem to optimally assign a moving object to be acquired by the sensor from a relationship between a position of the moving object and an area that can be acquired based on a position of the sensor and a direction of the sensor; and
an optimization processing means which maps the Ising model data to an annealing machine to obtain an execution result indicating a moving object to be assigned to the sensor.

(Supplementary note 12) A sensor control method comprising:
accepting input of position of a sensor that acquires a moving object and direction of the sensor, as well as position of the moving object:
constructing Ising model data that models an optimization problem to optimally assign a moving object to be acquired by the sensor from a relationship between a position of the moving object and an area that can be acquired based on a position of the sensor and a direction of the sensor:
mapping the Ising model data to an annealing machine to obtain an execution result indicating a moving object to be assigned to the sensor; and
controlling the sensor to acquire an assigned moving object based on the execution result.

(Supplementary note 13) The sensor control method according to Supplementary note 12, comprising:
constructing Ising model data representing an objective function that minimizes the number of missed acquisitions of moving objects assigned to each sensor so that the total number of resources used for acquiring one moving object across all sensors does not exceed a predetermined upper limit, with a constraint that the number of moving objects to be acquired by a sensor does not exceed a predetermined upper limit.

(Supplementary note 14) A storage medium for storing a sensor control program for causing a computer to execute:
an input process of accepting input of position of a sensor that acquires a moving object and direction of the sensor, as well as position of the moving object:
a model construction process of constructing Ising model data that models an optimization problem to optimally assign a moving object to be acquired by the sensor from a relationship between a position of the moving object and an area that can be acquired based on a position of the sensor and a direction of the sensor:
an optimization processing process of mapping the Ising model data to an annealing machine to obtain an execution result indicating a moving object to be assigned to the sensor; and
a control process of controlling the sensor to acquire an assigned moving object based on the execution result.

(Supplementary note 15) The storage medium according Supplementary note 14 for storing the sensor control program for causing a computer to execute:
Ising model data representing an objective function that minimizes the number of missed acquisitions of moving objects assigned to each sensor so that the total number of resources used for acquiring one moving object across all sensors does not exceed a predetermined upper limit, with a constraint that the number of moving objects to be acquired by a sensor does not exceed a predetermined upper limit, is constructed in the model construction process.

(Supplementary note 16) A sensor control program for causing a computer to execute:
an input process of accepting input of position of a sensor that acquires a moving object and direction of the sensor, as well as position of the moving object:
a model construction process of constructing Ising model data that models an optimization problem to optimally assign a moving object to be acquired by the sensor from a relationship between a position of the moving object and an area that can be acquired based on a position of the sensor and a direction of the sensor:
an optimization processing process of mapping the Ising model data to an annealing machine to obtain an execution result indicating a moving object to be assigned to the sensor; and
a control process of controlling the sensor to acquire an assigned moving object based on the execution result.

(Supplementary note 17) The sensor control program according Supplementary note 16, wherein
Ising model data representing an objective function that minimizes the number of missed acquisitions of moving objects assigned to each sensor so that the total number of resources used for acquiring one moving object across all sensors does not exceed a predetermined upper limit, with a constraint that the number of moving objects to be acquired by a sensor does not exceed a predetermined upper limit, is constructed in the model construction process.

### REFERENCE SIGNS LIST

10 Sensor
20 Moving object
100 Sensor control device
110 Device control unit
120 Storage unit
121 Sensor coordinates and various parameters database
122 Current target coordinates database
130 Input unit
140 Target coordinate estimation unit
150 Sensor control optimization unit
151 Ising model data construction unit
152 Annealing processing unit
160 Sensor control unit
170 New target detection unit
180 Output unit
200 Annealing machine

What is claimed is:

1. A sensor control system comprising:
a memory storing instructions; and
one or more processors configured to execute the instructions to:
accepting input of position of a sensor that acquires a moving object and direction of the sensor, as well as position of the moving object;
constructing Ising model data that models an optimization problem to optimally assign a moving object to be acquired by the sensor from a relationship between a position of the moving object and an area that can be acquired based on a position of the sensor and a direction of the sensor;
mapping the Ising model data to an annealing machine to obtain an execution result indicating a moving object to be assigned to the sensor; and
controlling the sensor to acquire an assigned moving object based on the execution result.

2. The sensor control system according to claim 1, wherein the processor is configured to execute the instructions to
constructing Ising model data representing an objective function that minimizes the number of missed acquisitions of moving objects assigned to each sensor so that the total number of resources used for acquiring one moving object across all sensors does not exceed a predetermined upper limit, with a constraint that the number of moving objects to be acquired by a sensor does not exceed a predetermined upper limit.

3. The sensor control system according to claim 1, wherein the processor is configured to execute the instructions to
constructing Ising model data that includes a constraint that suppress one sensor from using more resources than a predetermined number for the same moving object.

4. The sensor control system according to claim 1, wherein the processor is configured to execute the instructions to
constructing Ising model data including a constraint that increases sum of accuracy points calculated as a value indicating tracking accuracy, which becomes higher as the moving object is acquired by multiple resources and becomes higher as the moving object is closer to the sensor.

5. The sensor control system according to claim 4, wherein the processor is configured to execute the instructions to
constructing Ising model data including a constraint that increases sum of accuracy points indicating tracking accuracy defined so that it becomes higher as the angles between the radio waves irradiated according to the direction of the sensor are perpendicular to each other.

6. The sensor control system according to claim 1, wherein the processor is configured to execute the instructions to
constructing Ising model data including, in an objective function, a weighted formula that reduces a value of the objective function the more an important target, which is a moving object to be acquired preferentially, is assigned to the sensor.

7. The sensor control system according to claim 6, wherein the processor is configured to execute the instructions to
constructing Ising model data including, in the objective function, a formula that has an effect of reducing a value of the objective function when the important target is assigned to an important sensor, which is a sensor predetermined as a sensor that should acquire an important target.

8. The sensor control system according to claim 1, wherein the processor is configured to execute the instructions to
constructing model data representing a constraint and an objective function in QUBO-style.

9. The sensor control system according to claim 1, wherein the processor is configured to execute the instructions to:
deriving a set of moving objects that cannot be acquired from a relationship between a position of a sensor, a direction of the sensor, and a position of the moving objects; and
constructing a model that includes a constraint that suppresses assignment of moving objects in the set to the sensor.

10. A sensor control method comprising:
accepting input of position of a sensor that acquires a moving object and direction of the sensor, as well as position of the moving object;
constructing Ising model data that models an optimization problem to optimally assign a moving object to be acquired by the sensor from a relationship between a position of the moving object and an area that can be acquired based on a position of the sensor and a direction of the sensor;
mapping the Ising model data to an annealing machine to obtain an execution result indicating a moving object to be assigned to the sensor; and
controlling the sensor to acquire an assigned moving object based on the execution result.

11. The sensor control method according to claim 10, further comprising:
constructing Ising model data representing an objective function that minimizes the number of missed acquisitions of moving objects assigned to each sensor so that the total number of resources used for acquiring one moving object across all sensors does not exceed a predetermined upper limit, with a constraint that the number of moving objects to be acquired by a sensor does not exceed a predetermined upper limit.

12. A non-transitory computer readable information recording storage-medium for storing a sensor control program, when executed by a processor, that performs a method for:
accepting input of position of a sensor that acquires a moving object and direction of the sensor, as well as position of the moving object;
constructing Ising model data that models an optimization problem to optimally assign a moving object to be acquired by the sensor from a relationship between a position of the moving object and an area that can be acquired based on a position of the sensor and a direction of the sensor;
mapping the Ising model data to an annealing machine to obtain an execution result indicating a moving object to be assigned to the sensor; and
controlling the sensor to acquire an assigned moving object based on the execution result.

13. The non-transitory computer readable information recording storage-medium according claim 12, wherein
Ising model data representing an objective function that minimizes the number of missed acquisitions of moving objects assigned to each sensor so that the total number of resources used for acquiring one moving object across all sensors does not exceed a predetermined upper limit, with a constraint that the number of moving objects to be acquired by a sensor does not exceed a predetermined upper limit, is constructed in the model construction process.
